(19) United States
(12) Patent Application Publication
(10) Pub. No.: US 2007/0124522 A1
(43) Pub. Date: May 31, 2007

(54) Node detach in multi-node system

(76) Inventors: Brandon J. Ellison, Raleigh, NC (US); Eric R. Kern, Chapel Hill, NC (US); William B. Schwartz, Apex, NC (US); Adam L. Soderlund, Bahama, NC (US)

Correspondence Address: MARCIA L. DOUBET LAW FIRM, P.O. BOX 422859, KISSIMMEE, FL, 34742-2589, US

(21) Appl. No.: 11/290,071

(22) Filed: Nov. 30, 2005

(51) Int. Cl. G06F 13/24

(52) U.S. Cl. 710/260

(57) ABSTRACT

In a multi-node system, a node can be dynamically detached (e.g., responsive to an error situation) without impacting the operating system or others of the nodes. Contents of in-use memory at the node to be detached are copied to another node, and a memory map is updated to make the copy transparent to components using the memory. Furthermore, the copied-to memory locations are programmatically blocked to prevent assignment thereof to a memory requester.

### BACKGROUND OF THE INVENTION

The present invention relates generally to computer systems, and more particularly to dynamic detachment of node(s) in a multi-node system.

A multi-node system is one in which a plurality of nodes are interconnected. An example multi-node system is the xSeries® eServer™ x440 from the International Business Machines Corporation (“IBM”). (“xSeries” is a registered trademark, and “eServer” is a trademark, of IBM.) Multi-node systems provide massive redundancy and processing power, and therefore improve system availability, performance, and scalability.

A multi-node system might comprise, for example, 4 interconnected nodes, where each node comprises 8 processors, such that the overall system effectively offers 32 processors. Each node typically contributes memory resources that are shareable among the interconnected nodes.

Multi-node systems commonly use an system management interrupt architecture, referred to herein as “system management interrupt”, or “SMI”. When an interrupt vector is written to an SMI register, an SMI interrupt is generated. The interrupt is then handled by an SMI interrupt handler.

### BRIEF SUMMARY OF THE INVENTION

In one aspect, the present invention provides node detach in a multi-node system, comprising detecting an interrupt, by an interrupt handler of a particular one of the nodes of the multi-node system, and entering the interrupt handler to process the interrupt. Upon determining that the interrupt indicates that the particular node is to be detached from the multi-node system, this aspect further comprises: transparently hosting in-use memory of the particular node at a different one of the nodes which has available memory, such that subsequent references to the in-use memory are transparently resolved to the different one of the nodes; and then detaching the particular node from the multi-node system by not exiting from the interrupt handler.

In this aspect, the transparently hosting preferably further comprises: copying contents of the in-use memory to the different one of the nodes; creating a mapping between a location of the in-use memory at the particular node and a new location of the copied contents at the different node, wherein the mapping enables the transparent resolution for the subsequent references; marking unused memory at the particular node as unavailable; and marking the new location at the different node as unavailable.

In another aspect, the present invention provides node detach in a multi-node system comprising a plurality of interconnected nodes, wherein each of the nodes has associated therewith an interrupt handler for detecting and processing interrupts. This aspect preferably comprises: detecting, by the interrupt handler associated with a particular one of the nodes, an interrupt; entering the interrupt handler to process the interrupt; and nondisruptively detaching the node, responsive to determining that the interrupt indicates that the particular node is to be detached from the multi-node system.

In this aspect, the nondisruptive detach preferably further comprises: copying contents of in-use memory of the particular node to a different one of the nodes which has available memory; creating a mapping between a location of the in-use memory at the particular node and a new location of the copied contents at the different node, wherein the mapping enables subsequent transparent resolution of subsequent references to the in-use memory; marking unused memory at the particular node as unavailable; marking the new location at the different node as unavailable; and then detaching the particular node from the multi-node system by not exiting from the interrupt handler.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates a multi-node system;

FIGS. 2 and 3 provide flowcharts depicting logic which may be used when implementing preferred embodiments of the present invention; and

FIG. 4 (comprising FIGS. 4A-4C) illustrates an example scenario showing how memory contents from a detached node may be transparently hosted on a different node of a multi-node system.

### DETAILED DESCRIPTION OF THE INVENTION

Preferred embodiments are directed toward dynamically detaching one or more nodes in a multi-node environment (e.g., responsive to an error situation). Using techniques disclosed herein, a node can be detached without adversely impacting the operating system or others of the nodes. This node detach operation may be referred to as a “hot detach”—that is, it occurs dynamically, while the overall system continues to function. The node detach may be performed, for example, because the node is failing. Each node of the multi-node system contributes memory, which may be shared by other nodes at any particular point in time. If contents presently stored in the detaching node's memory just disappear during a node detach, the system would likely crash as a result; in addition, losing the memory contents may lead to results that are unpredictable. To avoid this undesirable situation, the contents of in-use memory of the node being detached are copied to another node, and a memory map is updated to make the copy transparent to the operating system for subsequent memory accesses. Furthermore, the copied-to memory locations are programmatically blocked to prevent accidentally overwriting the copy.

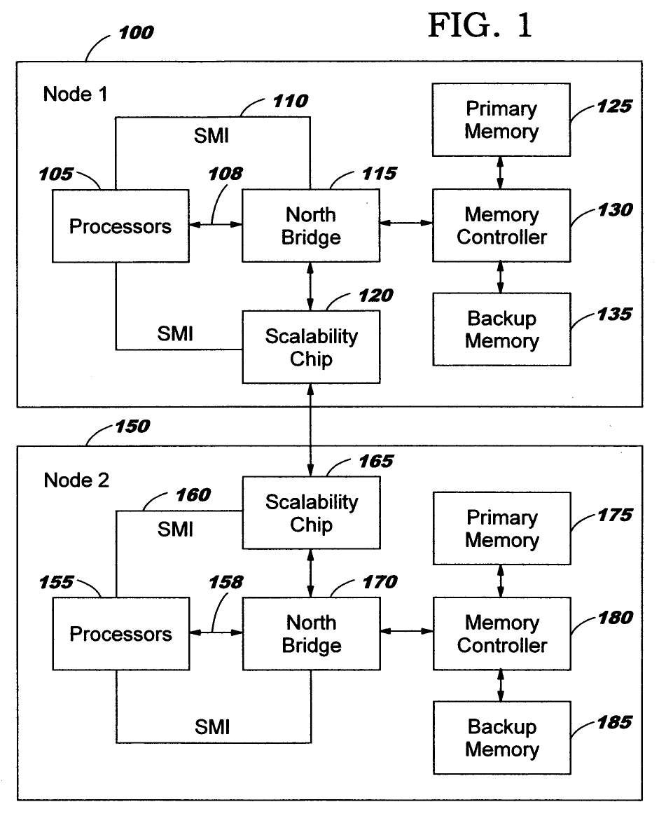

FIG. 1 illustrates a multi-node system comprising two nodes 100, 150. Each of these nodes may comprise a number of processors, as noted earlier. The processors are shown generally in FIG. 1 at reference numbers 105, 155. The memory contributed by each of the nodes is depicted, in FIG. 1, as primary memory 125, 175 and backup memory 135, 185. A memory controller 130, 180 in each node provides an interface between the node's memory and other components of the node 100, 150.

A so-called “north bridge” component 115, 170 may be present in each node. A north bridge component is present in a chipset architecture commonly known as “north bridge, south bridge”. In this architecture, the north bridge component communicates with a processor 105, 155 over a bus (see reference numbers 108, 158 in FIG. 1) and typically controls interactions with memory, advanced graphics, a cache, and a peripheral component interconnect (“PCI”) bus. Bus 108, 158 is commonly referred to as the “front-side bus”. The south bridge, not shown in FIG. 1, is generally responsible for input/output (“I/O”) functions, such as serial port I/O, audio, universal serial bus (“USB”), and so forth.

Embodiments of the present invention are not limited to this north bridge, south bridge chipset, however, and thus the depiction in FIG. 1 should be construed as illustrative but not limiting.

A scalability chip 120, 165 comprises one or more control fields, and is leveraged by preferred embodiments to enable information to be communicated among the nodes 100, 150 of the multi-node system (as will be described in more detail).

Each node of the multi-node system further comprises an SMI interrupt handler 110, 160. As noted earlier, when SMI interrupts are generated, they are handled by an SMI interrupt handler.

A shortcoming of prior art multi-node systems is that there is no way to bring down a single node, without bringing down the operating system and the other nodes in the multi-node system. Any of a variety of error conditions might occur at a particular node, for example, for which the particular node should be detached from (i.e., cease participating in) the multi-node system. These error conditions include, by way of illustration only, detecting that the node is overheating and detecting that the node is experiencing a memory leak. Disadvantages of shutting down an entire multi-node system because of conditions pertaining only to a single one of the nodes include reduced system availability and reduced system throughput.

Prior art multi-node systems synchronously enter system management mode, or “SMM”, at all nodes whenever any one of the nodes receives an SMI interrupt. In this mode, normal processing at all of the nodes is halted while the SMI interrupt handler evaluates the interrupt in an attempt to determine its cause. If the error is catastrophic, the SMI handler will typically generate a machine check, forcing a reboot of all of the nodes. However, in many cases, the causing event need not affect the other nodes. In these cases, rebooting those nodes needlessly wastes time and resources.

Preferred embodiments of the present invention enable the SMI interrupt handlers at the nodes to operate independently, such that an individual node can detach from the multi-node system in a non-disruptive way. Using techniques disclosed herein, the processors of a node to be detached enter system management mode, under control of the node's SMI interrupt handler, while the processors on other nodes continue normal operation. Notably, the other nodes can continue functioning after the detaching node is detached, and memory resources in use at the detaching node can be transparently mapped to different memory locations such that executing components do not lose access to contents of the memory from the detaching node.

SMI interrupts in a prior art multi-node system are typically propagated, across the interconnections that connect the nodes together, to the SMI handler for each node. In these systems, an SMI interrupt that impacts one node therefore impacts all nodes, causing them all to stop normal processing and enter their interrupt handlers. This is inefficient and can have undesirable effects on the overall system. Preferred embodiments leverage the scalability chip in the nodes, as noted earlier, to inhibit propagation of SMI interrupts among the nodes, thereby providing for node independence with regard to SMI interrupt handling. The hot detach operation provided by the present invention can therefore be isolated to detaching a single node.

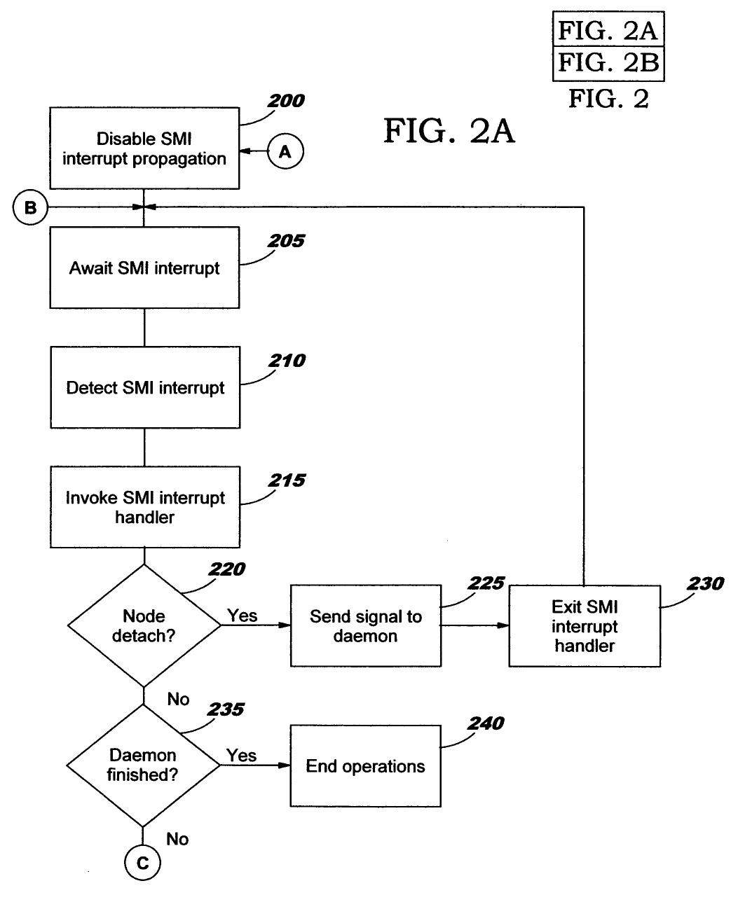

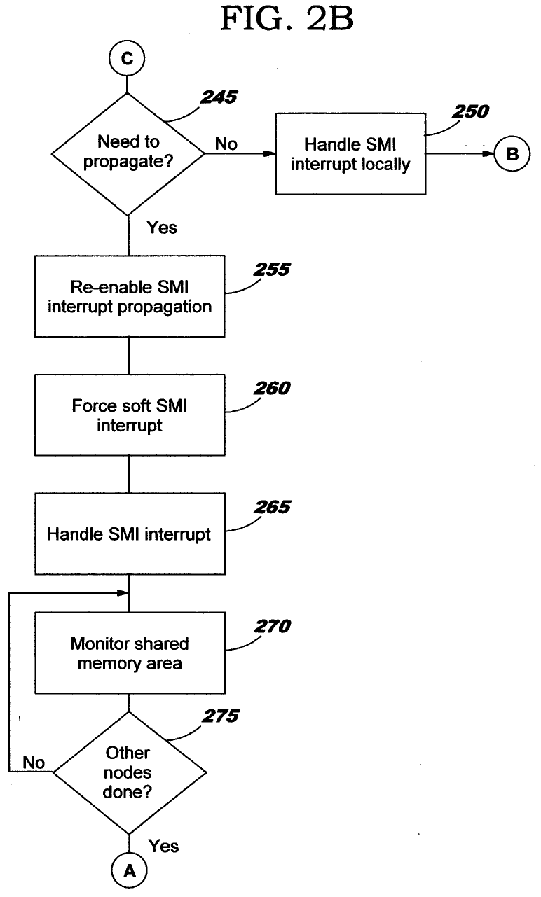

Referring now to FIG. 2, a flowchart is provided to illustrate logic that may be used when implementing preferred embodiments. As shown at Block 200 of FIG. 2, a control field is set in the scalability chip that disables SMI interrupt propagation among the nodes. Preferably, this control field is set as the nodes are powered up. The node then awaits detection of an SMI interrupt (Block 205).

When a node detects that an SMI interrupt has been generated (Block 210), the interrupt handler of only the detecting node is involved. Once invoked (Block 215), this SMI interrupt handler evaluates the interrupt to determine whether the interrupt indicates that the node needs to detach from the system (Block 220).

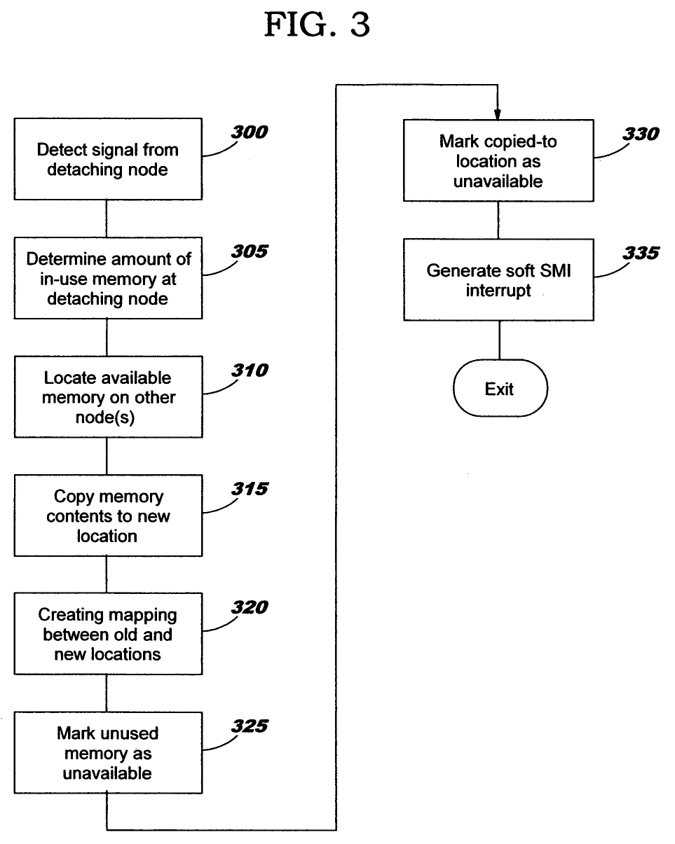

If the test in Block 220 has a positive result, then at Block 225, the interrupt handler sends a message, preferably using a shared memory structure, to a memory controller referred to herein as a “daemon” that runs under control of the operating system. This message instructs the daemon that the node is about to detach. After the node signals the daemon, it then exits its SMI interrupt handler (Block 230), and the daemon processes the node detach operations (as discussed below with reference to FIG. 3).

Once the daemon has finished, it generates another SMI interrupt to the local node. This interrupt is detected by the detaching node at Block 210, and the interrupt handler is entered again at Block 215. This time, the test in Block 220 has a negative result, and processing continues to Block 235, which tests to see whether the interrupt is a “daemon finished” signal from the daemon, signalling the detaching node that it has finished the detach processing.

If the test in Block 235 has a positive result, then control reaches Block 240, where the SMI interrupt handler of the detaching node does no further processing, and in particular, does not exit. The node is thus effectively removed from the system (although contents of the node's memory continue to be available, in the copied-to location(s), as discussed below with reference to FIG. 3).

While many SMI interrupts may be properly isolated to a single node, there may be other scenarios where one node generates an SMI interrupt that should be propagated among the nodes to prevent system misbehavior. To account for scenarios in which a node detects an SMI interrupt that should be propagated among the interconnected nodes, preferred embodiments implement logic as will now be described with reference to FIG. 2B. Control reaches Block 245 when the test in Block 235 (as well as the prior test in Block 220) has a negative result (i.e., the detected interrupt was not a signal from the daemon, and was not a node detach interrupt). Block 245 tests whether this is an interrupt that should be propagated to the other interconnected nodes.

If the test at Block 245 has a negative result, then the interrupt that was detected at Block 210 is an interrupt that is to be processed by the local node only (Block 250), using techniques which do not form part of the inventive concepts disclosed herein. Following completion of that processing, control returns to Block 205 to await the next SMI interrupt at this node.

When control reaches Block 255, an interrupt has been detected that needs to be propagated from the local node to the other interconnected nodes. Accordingly, SMI interrupt propagation is (re)enabled at Block 255. This preferably comprises resetting the control field in the scalability chip and initializing a shared memory area where the SMI interrupt handlers of the other nodes will communicate with this node. The local node then forces a soft SMI interrupt condition to occur (Block 260). Triggering this interrupt causes the interrupt that was detected at Block 210 to be propagated from the local node to the interconnected nodes. As a result, each of those nodes will detect the interrupt and then enter their SMI interrupt handler. Those SMI interrupt handlers will query the shared memory area as to the cause of the interrupt, and will then take appropriate action, depending on their configuration. Each node that finishes processing this interrupt records status in the shared memory area to indicate that it is finished. As indicated at Block 265, the local node may also take action to process this SMI interrupt locally.

The local node then monitors the shared memory area (Block 270) to determine whether the other interconnected nodes have finished their processing of the propagated interrupt. If all of the nodes have finished, then the test at Block 275 has a positive result, and control preferably returns to Block 200, where the local node again disables SMI interrupt propagation and awaits subsequent interrupts. Otherwise, when the test at Block 275 has a negative result, the local node continues to monitor the shared memory area at Block 270.

Turning now to FIG. 3, logic which may be used when implementing the daemon's processing during a node detach, whereby the detaching node's currently-used memory is to be hosted by a different node or nodes, will now be described. Using the daemon to perform the detach processing enables the local (i.e., detaching) node to reduce the time spent in its interrupt handler. (Alternatively, the SMI interrupt handler for the detaching node could perform the processing shown in FIG. 3. However, it may happen that the operating system needs to access the detaching node's memory while the memory-copying operating is occurring, and if the node's SMI interrupt handler performed the memory copying, then the memory would not be available to the operating system, due to the node being in its interrupt handler. This would likely bring the system down, or bring it to a stand-still, neither of which is desirable.)

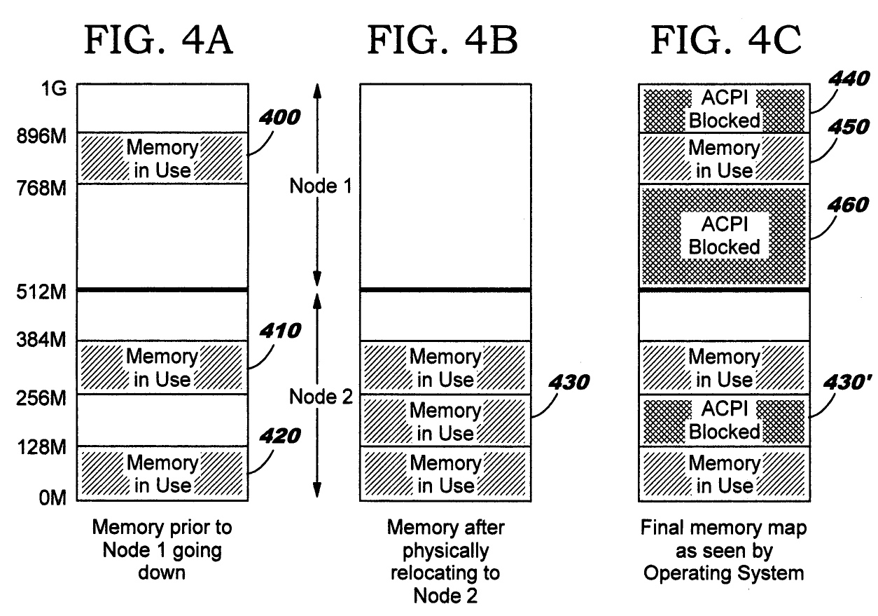

When the daemon detects that a node has signaled it to perform a node detach (Block 300), it determines how much memory is currently in use at the detaching node (Block 305). The daemon then searches for available memory on others of the nodes in the multi-node system (Block 310). Preferably, this comprises consulting a memory map that records what memory is currently available to the multi-node system. (Refer to FIG. 4A, where a memory map is illustrated graphically for a hypothetical scenario.) The memory in use at the detaching node is then copied to available memory on one or more of the other nodes (Block 315). In Block 320, the daemon then creates a mapping (e.g., a table or other data structure) that correlates between the original memory location on the detaching node and the copied-to memory location on the one or more other nodes, such that memory accesses using the original memory location can be transparently redirected to the new memory location(s). Using this mapping, the operating system does not see any change to the location of the data since the new memory location is mapped in the same address space. (That is, when memory contents are requested from a particular address which was provided by the detaching node, the mapping enables finding the current location of those contents in a manner that is transparent to the requester.)

The memory map is then revised (Block 325) to mark all currently unused memory locations on the detaching node as being unavailable, and (Block 330) to mark the copied-to location on the one or more other nodes as being unavailable. (Refer to FIG. 4C, which illustrates a result of this processing for a hypothetical scenarios) In preferred embodiments, this processing comprises adjusting advanced configuration and power interface (“ACPI”) tables, which are well known to those of skill in the art, to indicate that memory has been removed from the system and then remapping the physical memory. (This may also be referred to as describing a dynamic ACPI memory hole. The term “ACPI hole” refers to a structure in the ACPI structure space that indicates what memory is not available to the operating system.)

Finally, the daemon generates a soft SMI interrupt (Block 335), thereby signalling the detaching node that the daemon has finished its operations for detaching the node (i.e., that the memory copying and remapping operations are finished). The daemon then exits the processing of FIG. 3.

FIGS. 4A-4C illustrate an example scenario showing how memory contents from a detached node may be transparently hosted on a different node of a multi-node system. This example uses a memory map for a two-node system, although it will be obvious to one of skill in the art that the teachings disclosed herein apply equally to multi-node systems comprising more than two nodes.

In FIG. 4A, node 1 contributes memory that is addressed from address 512M through address 1G. See reference number 400. In the example scenario, when node 1 is to be detached, the memory that is currently used comprises addresses 768M through 896 M, which is a 128M block. Node 2 contributes memory that is addressed from address 0M through 512M, and at the time when node 1 is to be detached, the memory currently used from node 2 comprises addresses 0M through 128M and 256M through 384M. See reference numbers 410 and 420.

The daemon determines, in this example scenario, that all of the currently-used memory from node 1 can be copied to a contiguous block of node 2 memory, from address 128M through address 256M. FIG. 4B therefore illustrates that the in-use memory from node 1 has been copied to this memory of node 2. See reference number 430. (It may also happen that no sufficiently large contiguous blocks are available for the memory to be copied. In this case, the memory from node 1 may be copied to multiple locations, and the memory map will then reflect these multiple locations to enable transparent access to the copied memory contents.) FIG. 4B also illustrates that, after the memory contents from the detaching node are physically moved, none of the memory from that node (shown in the example as addresses 512M through 1G) is now in use.

FIG. 4C shows the final memory map for the example scenario, with available and unavailable memory as seen by the operating system. As discussed above with reference to Block 325, all of the detaching node's currently-available (i.e., unused) memory is marked as unavailable, or blocked, during the detach operation. (This prevents other nodes from attempting to use the memory that is being removed with the detaching node.) See reference numbers 440 and 460 for address locations that are blocked off as a result of the detach. The operating system continues to see addresses 768M through 896M, which were previously contributed by node 1, as being in use. See reference number 450. However, the mapping created by the daemon during the memory copying operation (as discussed with reference to Blocks 315-320) transparently resolves references to these locations, such that contents copied to addresses 128M through 256M of node 2 are used instead. Accordingly, the memory map as seen by the operating system has addresses 128M through 256M of node 2 marked as blocked (and therefore unavailable for assigning to a requester). See reference number 430′.

As will be appreciated by one of skill in the art, embodiments of the present invention may be provided as methods, systems, and/or computer program products comprising computer-readable program code. Accordingly, the present invention may take the form of an entirely software embodiment, an entirely hardware embodiment, or an embodiment combining software and hardware aspects. In a preferred embodiment, the invention is implemented in software, which includes (but is not limited to) firmware, resident software, microcode, etc.

Furthermore, embodiments of the invention may take the form of a computer program product accessible from computer-usable or computer-readable media providing program code for use by, or in connection with, a computer or any instruction execution system. For purposes of this description, a computer-usable or computer-readable medium may be any apparatus that can contain, store, communicate, propagate, or transport a program for use by, or in connection with, an instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, removable computer diskette, random access memory (“RAM”), read-only memory (“ROM”), rigid magnetic disk, and optical disk. Current examples of optical disks include compact disk with read-only memory (“CD-ROM”), compact disk with read/write (“CD-R/W”), and DVD.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention. Furthermore, it should be understood that use of “a” or “an” in the claims is not intended to limit embodiments of the present invention to a singular one of any element thus introduced.

What is claimed is:

1. A programmatic method for providing node detach in a multi-node system, comprising steps of:
detecting, by an interrupt handler of a particular one of the nodes of the multi-node system, an interrupt;
entering the interrupt handler to process the interrupt; and
upon determining that the interrupt indicates that the particular node is to be detached from the multi-node system, performing steps of:
transparently hosting in-use memory of the particular node at a different one of the nodes which has available memory, such that subsequent references to the in-use memory are transparently resolved to the different one of the nodes; and
then detaching the particular node from the multi-node system by not exiting from the interrupt handler.

2. The method according to claim 1, wherein the transparently hosting step further comprises the steps of:
copying contents of the in-use memory to the different one of the nodes;
creating a mapping between a location of the in-use memory at the particular node and a new location of the copied contents at the different node, wherein the mapping enables the transparent resolution for the subsequent references;
marking unused memory at the particular node as unavailable; and
marking the new location at the different node as unavailable.

3. The method according to claim 2, wherein the copying step, the creating step, the marking unused memory step, and the marking the new location step are performed by a memory controller daemon executing under control of an operating system of the multi-node system.

4. The method according to claim 3, wherein the memory controller daemon is signaled to begin, by the interrupt handler, responsive to the determining step.

5. The method according to claim 4, wherein the transparently hosting step further comprising the steps of:
exiting the interrupt handler, responsive to signaling the memory controller daemon, until receiving a new interrupt indicating that the memory controller daemon has concluded the copying step, the creating step, the marking unused memory step, and the marking the new location step;
re-entering the interrupt handler to process the new interrupt, wherein the processing of the new interrupt comprises not exiting the interrupt handler.

6. The method according to claim 5, wherein the exiting step allows the operating system to continue accessing the in-use memory.

7. The method according to claim 4, wherein the signal is passed from the interrupt handler to the memory controller daemon using shared memory.

8. The method according to claim 3, wherein the memory controller signals the interrupt handler upon conclusion of the copying step, the creating step, the marking unused memory step, and the marking the new location step.

9. The method according to claim 1, wherein the particular node is configured to prevent propagation of the detected interrupt from the particular node to others of the multiple nodes.

10. The method according to claim 9, wherein the propagation is prevented by setting a control field associated with the particular node during a power-up process of the particular node.

11. A system for providing node detach in a multi-node system, comprising:
a multi-node system comprising a plurality of interconnected nodes, wherein each of the nodes has associated therewith an interrupt handler for detecting and processing interrupts;
means for detecting, by the interrupt handler associated with a particular one of the nodes, an interrupt;
means for entering the interrupt handler to process the interrupt; and
means for nondisruptively detaching the node, responsive to determining that the interrupt indicates that the particular node is to be detached from the multi-node system, further comprising:
means for copying contents of in-use memory of the particular node to a different one of the nodes which has available memory;
means for creating a mapping between a location of the in-use memory at the particular node and a new location of the copied contents at the different node, wherein the mapping enables subsequent transparent resolution of subsequent references to the in-use memory;
means for marking unused memory at the particular node as unavailable;
means for marking the new location at the different node as unavailable; and
means for then detaching the particular node from the multi-node system by not exiting from the interrupt handler.

12. A computer program product for node detach in a multi-node system, the computer program product comprising at least one computer-usable media storing computer-readable program code, wherein the computer-readable program code, when executed on a computer, causes the computer to:
detect, by an interrupt handler associated with a particular one of the nodes of the multi-node system, an interrupt;
enter the interrupt handler to process the interrupt; and
nondisruptively detach the node, responsive to determining that the interrupt indicates that the particular node is to be detached from the multi-node system, further comprising:
copying contents of in-use memory of the particular node to a different one of the nodes which has available memory;
creating a mapping between a location of the in-use memory at the particular node and a new location of the copied contents at the different node, wherein the mapping enables subsequent transparent resolution of subsequent references to the in-use memory;
marking unused memory at the particular node as unavailable;
marking the new location at the different node as unavailable; and
then detaching the particular node from the multi-node system by not exiting from the interrupt handler.
